(19) United States
(12) Patent Application Publication
(10) Pub. No.: US 2008/0204706 A1
(43) Pub. Date: Aug. 28, 2008

(54) System For Distributed Measurement of the Curves of a Structure

(76) Inventors: Sylvain Magne, Chatillon (FR); Pierre Ferdinand, Houilles (FR)

Correspondence Address: THELEN REID BROWN RAYSMAN & STEINER LLP, P. O. BOX 640640, SAN JOSE, CA, 95164-0640, US

(21) Appl. No.: 10/592,571

(22) PCT Filed: Mar. 9, 2005
(86) PCT No.: PCT/FR05/50152

§ 371 Date: Mar. 24, 2008

(30) Foreign Application Priority Data
Mar. 11, 2004 (FR) 0450495

(51) Int. Cl. G01B 11/16; G01L 1/24

(52) U.S. Cl. 356/32; 356/35.5

(57) ABSTRACT

The invention relates to a system for distributed or dispersed measurement of axial and bending deformations of a structure including at least one threadlike device (10) equipped for the distributed or dispersed measurement of these axial and bending deformations, and means for processing measurement signals generated by said device, in which each device includes a cylindrical reinforcement (11) supporting, at its periphery, at least three optical fibres (12) locally parallel to the axis of the reinforcement, and in which the processing means implement means for spectral or time division multiplexing of signals coming from optical fibres.

### TECHNICAL FIELD

The invention relates to a system for distributed measurement of the curves of a structure, including a threadlike cable device equipped for such a measurement and means for processing measurement signals generated by said device.

### PRIOR ART

In the field of civil engineering construction (buildings, bridges, roadways, railway tracks, etc.), non-uniform settlements and even unforeseen collapses (localised collapses) can cause serious accidents, aboveground and underground, and lead to very high repair costs. Such events can be due to the existence of natural or artificial cavities (mines, tunnels, etc.) that are not indexed or, if they are known, insufficiently consolidated and overloaded.

Public works companies want to have a measurement system suitable for existing structures (or structures under construction), making it possible to monitor the precise changes (spatially, along a horizontal plane) in the ground settlement and to set off an alarm in the event of a rupture indicating a local collapse. The sensitive portion (in contact with the ground) of such a measurement system should be capable of being installed easily under an existing structure by a tunnel with a small diameter (as unintrusive as possible) so as not to disturb the stability of said structure. This sensitive portion should also be capable of being transported (for example, on a strand typically with a diameter of 1 to 2 meters) and fitted without too much trouble in the measuring site. The desired resolution for a settlement would be on the order of a millimetre or even less so as to be capable of anticipating more significant future degradation modes. The extend of the zone to be surveyed, which is variable according to the application, should range from several dozen to several hundred meters, and sometimes even more.

There are currently traditional measurement means (theodolites, inclinometers, strain gauges, LVDT (“Linear-Variable Differential Transformer”) sensors) that make it possible to perform specific measurements in locations considered to be representative of a civil engineering structure so as possibly to obtain information about the behaviour of the underground. Such means (indirect) do not make it possible to know precisely the exact behaviour of a ground settlement.

Other methods for measuring collapse are implemented, such as the range of a remote pressure sensor in a test tunnel filled with mercury. The distributed pressure measurement makes it possible to obtain the variation in elevation with respect to a reference point located out of the area. However, these methods are neither effective enough in terms of precision, nor fast enough, and are moreover expensive to carry out because they require the use of personnel.

There are also bending or curvature sensors.

A prior art document, referenced [1] at the end of the description, describes optical fibre bending or curvature sensors, in which light losses are measured in a corrugated or textured area of the fibre subjected to bending. When bending occurs in the diametral plane passing through such a corrugated area, some of the light injected into the fibre is lost toward the outside, in proportion to the magnitude of this bend. By then measuring the proportion of light lost, it is possible to deduce the curvature radius therefrom, or an angle of rotation of one structure with respect to another. When the orientation of the curvature is not known, a three-fibre system, of which the respective textures are placed at 120° with respect to one another in a “rosette”-type configuration, can be used. The measurement of the three light transmission coefficients makes it possible to deduce the two main components of the curvature radius in the cross-section plane of the fibres and the orientation of these main curvatures with respect to the position of the sensor on the structure to be monitored.

In this document, temperature sensitivity is not mentioned. This leads to a practical difficulty in outside use where the climatic conditions are not controlled. Moreover, such sensors require as many fibres as points of measurement (one point of measurement per fibre to prevent any ambiguity) and therefore become very difficult and expensive to wire when there is a large number of points of measurement. Moreover, the measurement principle does not mention methods for compensation of fluctuations in optical intensity, other than those expected, which are capable of distorting the measurement. Indeed, any optical loss, regardless of its origin, can then be incorrectly attributed to a curvature variation. Such fluctuations can occur as a result of connection problems, ageing of glued joints, microbends along the measurement fibre, and so on. In addition, as it is necessary to calibrate the sensors one-by-one and the setting can change over time (for the same reasons as above), thereby necessitating periodic recalibration of the sensors, which is costly and not always feasible at the site, in particular if the structure is sealed underground.

The invention aims to overcome the disadvantages listed above, by proposing a system for distributed measurement of curvatures of a structure including at least one threadlike cable device equipped for such a measurement and means for processing measurement signals generated by said device, making it possible to perform measurements with very little intrusiveness, for example for a ground settlement under a civil engineering infrastructure that exists or that is under construction, so as to possibly locate the collapses and determine the distribution of pulls along its axis independently of its torsional state.

### DESCRIPTION OF THE INVENTION

The invention relates to a system for distributed or dispersed measurement of axial deformations and bending of a structure including at least one threadlike device equipped for the distributed or dispersed measurement of these axial and bending deformations, and means for processing measurement signals generated by said device, characterised in that each device includes a cylindrical reinforcement supporting, at its periphery, at least three optical fibres locally parallel to the axis of the reinforcement, and in which the processing means implement means for spectral or time division multiplexing of signals coming from the optical fibres.

According to a first measurement principle, each fibre has at least one Bragg grating transducer, wherein the processing means allow for a distributed measurement and the multiplexing means are wavelength multiplexing means.

According to a second measurement principle, the processing means allow for a dispersed measurement carried out by the Brillouin reflectometry method.

In an advantageous embodiment, the optical fibres are arranged in at least three grooves formed at the edge of the reinforcement.

Advantageously, said system includes at least one additional optical fibre that makes it possible to perform a temperature self-compensation, which can comprise Bragg gratings distributed along its entire length. This additional optical fibre can be inserted freely into a low-friction plastic capillary. Advantageously, the device includes an outer casing. The reinforcement is advantageously obtained by pultrusion of a glass-epoxy- or glass-vinyl ester-type composite material. Advantageously, metal fasteners can be crimped on the reinforcement. The fibres can be recollected via a multistrand optical cable that transmits the measurement to the processing means.

In another advantageous embodiment, the reinforcement is created by a positioning fibre. The device includes seven fibres having the same diameter self-positioned in a hexagonal mode, three of said fibres, distributed by 120° at the periphery of the reinforcement, being optical fibres. These fibres can be coated with a polymer glue, or held by a capillary. If the reinforcement is an optical fibre, at least one Bragg grating can be imprinted therein so as to allow for temperature compensation.

The system of the invention can comprise a plurality of devices arranged in various positions and according to various angular orientations under the structure concerned, through unintrusive tunnels, which can be refilled after installation. A ground settlement resulting from works and during the life of the structure is then manifested by a pull on the device (caused by friction with the ground) as well as by a change in the local curvatures, which are then measured directly via the local deformations borne by the device.

The device of the invention makes it possible to establish a measurement (along the entire axis thereof) of the deformations caused by the axial pull thereof as well as the distribution of the deformations caused by bending (radius of curvature, orientation of the curvature plane) making it possible to calculate the settlement that has occurred since its installation.

A plurality of measurement techniques can be applied to optical fibres, differentiated according to whether they are continuous (dispersed) or point-specific (distributed).

Various methods for distributed measurement (in the sense that the measurement is performed at a number of points located at various positions along the cable) can be envisaged for equipping the device of the invention. The Bragg grating transducers are the sensors most commonly used industrially and in particular in the civil engineering sector. White-light interferometric sensors (“white-light interferometry”) can be used as strain gauges glued or attached to the surface of the structure to be monitored for deformation. These sensors do not require recalibration after a reconnection, unlike the monochromatic light interferometers. Other sensors, such as Fabry-Perot interferometer-type sensors, do not allow for multiplexing along the same fibre because they work by fibre-end reflection. Moreover, they often use the entire spectral width of the optical source so as to minimise the coherence length and thus improve the spatial resolution. Therefore, they must be arranged in a grating according to a parallel organisation (by optical switching).

A dispersed measurement (i.e., continuous along the device) can also be performed by the Brillouin reflectometry method (“Brillouin Optical Time Domain Reflectometry”, B-OTDR), as described in the document referenced [2]. This method is increasingly used because it makes it possible to perform measurements of axial deformation applied to the fibre as well as of the temperature thereof. However, B-OTDR systems are expensive, and allow only static measurements to be taken (response time changing between several minutes and several hours). Moreover, the precision of the deformation measurement is on the order of 100 micrometers/meter, which is between 20 and 100 times less effective than with Bragg gratings. This solution nevertheless remains competitive for very long cables in which the number of Bragg grating transducers is high (over 200).

The system of the invention has the following advantageous functionalities:

It makes it possible to perform distributed measurements of the overall state of curvature of the device connected to the underground over hectometric (and even kilometric) distances, and to determine the change in the settlement under an infrastructure concerned (metric spatial precision and precision in millimetric depth). Indeed, a depth is not directly measured, but rather the distribution of bending deformations along the device is measured, representing the distribution of the radii of curvature and thus the second derivative of the distribution of the settlement. An appropriate signal processing procedure then makes it possible to obtain the distribution of this settlement along the device.

The cylindrical profile of the device of the invention is advantageous. Indeed, in addition to the facility of production, it is clear that for reasons of manageability on the site, it is difficult to ensure that a planar structure (such as a tape, for example) retains its preferential orientation (horizontal sensor plane) as it goes through a long tunnel (several hundred meters) having a small diameter due to friction forces. The device of the invention on the other hand is free to twist and be subjected to axial pulling, the measurements of curvature being independent of its torsional and pulling state. This reconstruction of the distribution of the bending moments independent of the torsional state is made possible by a concept inspired by “rosettes” in which the deformations are measured at the circumference of the device at precise angular orientations (for example, every 120°).

The invention makes it possible to handle a very large number of transducers owing to the wavelength multiplexing (solution based on Bragg gratings) or the time-resolved measurements (OTDR-Brillouin) and guarantees stable measurements over the long-term because all of the sensors recommended (Bragg gratings, B-OTDR, white-light interferometers) are insensitive to optical power fluctuations (disconnection-reconnection as desired, with no need for recalibration).

The structure to which the optical fibres are attached is the device itself, without any associated mechanics, which is advantageous in terms of bulk, weight and cost. Moreover, the instrumentation of the device can be performed rapidly and continuously owing to a winding method (winding-unwinding). Finally, the orientation of the curvature with respect to the external structure does not require additional sensors, because the measurement of the curvature in the invention is independent of the torsional state of the device.

The identification of a rupture in the structure concerned (due to a ground collapse) is made possible by an interrogation by the two ends of the device. The identification of the sensors present on the line makes it possible to locate the rupture. This advantage is possible with Bragg grating technology or B-OTDR technology.

A matrix representation can be obtained by the juxtaposition of a plurality of devices of the invention in at least two directions (advantageously orthogonal) and different locations under the infrastructure to be monitored in order to obtain a two-dimensional mapping of the development of a settlement.

### BRIEF DESCRIPTION OF THE DRAWINGS

FIGS. 1A and 1B show a first embodiment of the device of the invention equipped with Bragg grating transducers, in a longitudinal and a cross-sectional representation, respectively.

FIG. 2 shows a second embodiment of the device of the invention.

FIG. 3 shows the installation of the device of the invention for the measurement of settlements resulting from excavations.

### DETAILED DESCRIPTION OF SPECIFIC EMBODIMENTS

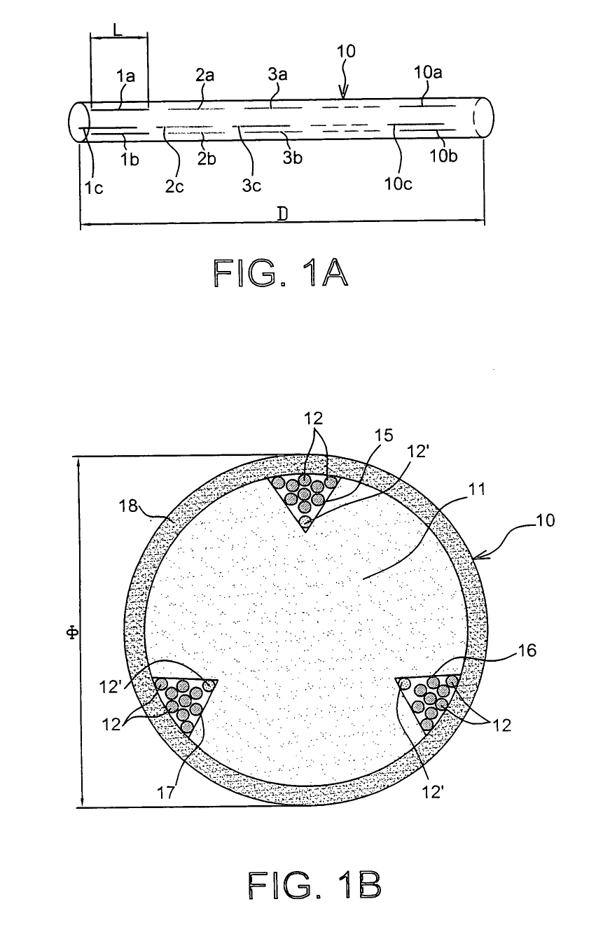

The system of the invention includes a threadlike cable device 10, shown in FIGS. 1A and 1B, equipped for the distributed measurement of curvatures of a structure, in particular a ground settlement. This device 10 is connected to processing means not shown in the figures. This device includes a cylindrical reinforcement 11, which can be solid or hollow, supporting, at its periphery, at least three optical fibres 12 locally parallel to the axis of the reinforcement, arranged for example in three grooves 15, 16 and 17. These fibres can be, for example, pultruded or glued in these grooves. These fibres have, for example, a plurality of Bragg grating transducers, distributed over the circumference of said device in a rosette-type pattern, the transducers being arranged in this case at 120° with respect to one another. The relative wavelength variations of these transducers make it possible to measure the distribution of the deformations caused by the local bending and pulling state and the temperatures of said device.

FIG. 1A diagrammatically shows fibres numbers 1a, 2a . . . 10a arranged in groove 15, fibres numbers 1b, 2b . . . 10b arranged in groove 16, and fibres numbers 1c, 2c . . . 10c arranged in groove 17. By way of example, six Bragg gratings were photoimprinted on each of the fibres, using known techniques, and distributed every meter. Fibres 1a, 1b and 1c make it possible to measure the deformations over the first six meters, fibres 2a, 2b and 2c over the next six meters, and so on.

In FIG. 1B, the three fibres 12′ correspond to the fibres comprising a Bragg grating in the cross-section plane considered.

The reinforcement 11 can be hollow or solid. In addition, it can be made of metal, or advantageously a composite material for reasons of weight and deformation and corrosion resistance.

The device of the invention comprises, in addition, an outer casing 18 protecting the transducers and ensuring the transfer of the optical connection to a measuring unit.

In an advantageous embodiment, described below, Bragg grating transducers are used, the fibres bearing Bragg gratings in clearly determined locations. Other embodiments are possible. In particular, it is possible to use optical fibres interrogated by the B-OTDR method. In this other embodiment, only one fibre is necessary, but for all practical purposes, at least one-fibre per groove is considered for reasons of redundancy.

### Embodiment

### Metrological Properties of Bragg Gratings

The wavelength of a Bragg grating varies directly with the temperature T and the deformations ε according to the axis of the fibre.

The relative variation of the Bragg wavelength of a Bragg grating (free grating, unglued) as a function of temperature, is thus written:

$$\frac{Δ {λ}_{B}}{{λ}_{B}} = a Δ T = ( α + ξ ) Δ T \approx 7 \cdot {10}^{- 6} \cdot Δ T \qquad ( 1 )$$

At the wavelength of 1.55 μm, this coefficient is on the order of 10 to 12 pm/K according to the optical fibres. When the Bragg grating is glued to a composite structure (glass-epoxy), it undergoes a deformation corresponding to the thermal dilation of this structure and the temperature law is rewritten as follows:

$$\frac{Δ {λ}_{B}}{{λ}_{B}} = {a}^{′} \cdot Δ T = ( ( 1 - pe ) \cdot {α}_{s} + ξ ) Δ T \approx 13 \cdot {10}^{- 6} \cdot Δ T \qquad ( 2 )$$

Similarly, the relative variation in Bragg wavelength as a function of the deformation involves the deformation itself and the variation in refraction index induced by this deformation (elasto-optical effect) according to the relation:

$$\frac{{Δλ}_{B}}{{λ}_{B}} = ( 1 - pe ) ɛ = 1 - ( \frac{{n}_{e}^{2}}{2} ( {p}_{12} ( 1 - v ) - {p}_{11} v ) ) \cdot ɛ = 0 , 78 \cdot ɛ \qquad ( 3 )$$

where ε is the longitudinal deformation,
nₑ is the index of the core (typically 1.47),
p₁₁ and p₁₂ are elasto-optical coefficients of silica (p₁₁=0.113; p₁₂=0.252),
ν is the Poisson coefficient of silica (typically 0.17), and pₑ is the photoelastic constant of silica (typically 0.22).

At the wavelength of 1.55 μm, the coefficient is around 1.21 pm/micrometer/meter and is substantially dependent on the silica doping.

The advantages of Bragg grating metrology are in particular the following:

no electromagnetic interference (optical measurement),

wavelength multiplexing and reading (spectral signature independent of fluctuations in optical power),

point-specific measurements (local),

significant transfer of the measurement (kilometric ranges) and flexibility of wiring,

stability over time and durability in harsh environments,

linear measurements over a usual temperature range (−20° C., +50° C.),

no need for a permanent connection (instrumentation can be connected and disconnected as desired),

very low insertion losses allowing for a series arrangement of sensors along a single measurement line,

optimisation of the cost of the point of measurement by virtue of the multiplexing by a single acquisition unit,

multiparameter measurements (temperature, deformations) standardised in a single acquisition unit and a single processing and display protocol (coherence in the analysis and storage of data).

### Production of the Support Reinforcement

The most commonly used composites for the reinforcement 11 are glass fibres bound by an epoxide or vinylester polymer matrix. These materials are usually obtained by a pultrusion process that consists of assembling parallel fibres, drawn through a resin bath. One such process is described in the document referenced [3]. Once impregnated, the fibres are drawn through a heated drawplate. Then, the polymerisation of the resin is performed in areas for heating then for controlled cooling. The profiles obtained are then cut to the desired length as they come out of the drawplate. Metallic fasteners can optionally be crimped on the composite reinforcements produced by pultrusion, as described in the document referenced [4]. Attachment nuts then make it possible to attach a pulling line enabling the device to be pulled through test tunnels in the ground.

### Instrumentation of the Reinforcement

One solution consists of inserting the fibres in chosen orientations at the level of the supply mandrel of the pultrusion machine. This solution is suitable for a large-scale industrial situation.

Another solution consists of gluing the fibres after production of the pultruded reinforcement in grooves specifically formed for this purpose. This small-scale approach is described below.

The deformation measurements are carried out by three series of Bragg grating transducers housed in grooves 15, 16 and 17 formed in specifically defined angular orientations (advantageously every 120° C.), so that the maximum amplitude of the deformation caused by the curvature is always determined independently of the torsional state of the device and its longitudinal pulling state. At least three grooves must be formed at the periphery of the device. It is indeed possible to have more than three grooves for reasons of redundancy. The number of transducers results from a technical-economic compromise. By way of example, for a spatial period of 1 meter, a cable 60 meters long comprises 180 transducers. This situation is considered as an example below.

Bragg gratings are periodically photoimprinted (every meter) on each fibre, which is relined after photoimprinting, these gratings being precisely located. The Bragg grating transducers are placed by series of three, as shown in FIG. 1A, so that at each abscissa x, three wavelength shifts representing three deformations measured along the section are associated. For each of the three grooves 15, 16 and 17, it is necessary to place a plurality of fibres in parallel making it possible to “cover” the entire length of the device.

The multiplexing capacity is a function of the measurement range chosen, with an example of multiplexing being given in the document referenced [4]. By way of example, let us consider a deformation range of ±0.15%, which corresponds to a spectral shift of around ±1.8 nm (at 1.55 μm), i.e. 3.6 nm. Overlapping this spectral shift of mechanical origin is a wavelength shift of thermal origin (typically ˜20 pm/° C. at 1.55 μm). For the ambient use range [0° C., +30° C.], this corresponds to a wavelength shift of around 0.6 nm. The total spectral shift (thermal+mechanical) is therefore 4.2 nm. By maintaining a safety margin (deterring any spectral overlapping), the optical bandwidth allocated to each transducer is therefore typically 5 nm. Since the optical bandwidth of the system is typically on the order of 30 nm (conventional band called C band), the number of transducers placed on each measurement fibre portion is therefore six gratings per fibre for this deformation range. The use of a spectrally wider source (band C+L) proportionally increases the number of multiplexable Bragg gratings per fibre.

These metrological values are considered below as an example. It is thus possible to place an RBi assembly of six Bragg gratings per fibre, distributed every meter. The RBi assembly therefore extends over a length L=6 m. For each groove, an assembly of ten fibres thus makes it possible to cover a length D of 60 meters as shown in FIG. 1A. An additional optical fibre (placed in one of the three grooves) can be added so as to achieve a temperature self-compensation. For example, this additional optical fibre can have six Bragg gratings distributed every ten meters. It can be freely inserted into a low-friction plastic capillary (for example, Teflon) so that the gratings are sensitive only to temperature.

For reasons of reliability and simplicity of implementation, for a given measurement line, the Bragg gratings are all photoimprinted on the same fibre (there is no weld between them). It is therefore necessary to ensure the mechanical reliability of all six transducers photoimprinted on the same fibre. This reliability is provided by the so-called “purge test” method, which consists of exerting a rapid pull of the fibre until there is a test deformation so as to ensure that the transducer resists this deformation. This method is implemented on a special mechanical set called “proof-tester”, which makes it possible to perform a calibrated and reproducible pull. This “purge test” by default applies a deformation of 1%, which can reach 2% or more.

In FIG. 1B, which shows a section of the device of the invention, a measurement fibre 12′, which comprises a Bragg transducer in the section considered, is glued at the base of each groove 15, 16 and 17 while nine other fibres 12 pass above so as to be brought to each end of the device. By way of indication, the dispersed fibre length is therefore 30×60 m=1800 m.

The characteristics of the device of the invention are summarised in the table below.

| Parameter | Value | Observations |
|---|---|---|
| Length of the | 60 m | Length |
| device | | conditioned by |
| | | the multiplexing |
| | | capacity and by |
| | | the spatial |
| | | period |
| Mechanical | ~5 mm | Safety |
| diameter of the | | dimensioning |
| device | | associated with |
| | | the deformations |
| | | imposed by the |
| | | curvature during |
| | | reel storage |
| External diameter | ~6 mm | |
| Number of Bragg | 6 | Number limited by |
| gratings per | | the wavelength |
| fibre | | multiplexing |
| | | capacity |
| Number of fibres | 10 | |
| on a groove | | |
| Number of | 3 | Grooves produced |
| equipped grooves | | at 120° (“delta” |
| | | configuration) |
| | | with respect to |
| | | one another |
| Total number of | 180 | Number of grooves × number |
| Bragg deformation | | of |
| gratings | | fibres/groove × number |
| | | of Bragg |
| | | gratings/fibre |
| Number of Bragg | 6 | A Bragg grating |
| temperature | | for measuring |
| gratings | | temperature every |
| | | 10 meters (non- |
| | | limiting choice) |

As shown in the equation (8) below, the deformation increases as a function of the curvature (and therefore increases insofar as the curvature radius decreases). The diameter of the device of the invention must therefore be smaller as the curvature radii to be measured are very small (for example, some 0.1 mm⁻¹).

The profile of this device, among the smallest that can be obtained by pultrusion, is shown in FIG. 2. This other solution corresponds to a device with seven fibres self-positioned according to a hexagonal pattern, the reinforcement being provided in this case by a positioning fibre 25. Three optical fibres 26, 27 and 28 are arranged at the edge of this fibre 25, at 120° with respect to one another, by being separated by positioning fibres 29. The fibres all have the same diameter and are preferably lined with polyimide. The standardised diameter of single-mode optical fibres used in telecommunications is 125 μm. With a polyimide coating, the external diameter (Φₑₓₜ) is on the order of 135 μm. Some companies propose fibres having smaller diameters on the order of 80 μm (around 90 μm with polyimide coating) and even 40 μm. These fibres can thus support even smaller curvature radii in proportion to their diameter. As the production of fibres is subject to strict standards with respect to size, it is advantageous to use the same fibres to produce a self-positioned assembly. Nevertheless, it is also possible to envisage substituting certain optical fibres (positioning fibres 29) with fibres having the same diameter but a different material, such as carbon fibres, so as to ensure good rigidity.

The seven fibres 25, 26, 27, 28 and 29 are placed in a drawplate that orders them according to the hexagonal position shown in FIG. 2. They are then coated with a polymer glue 30 (for example epoxy), which holds them in position. Alternatively, the fibres can also be held by a capillary having an internal diameter equal to around three times the diameter of the fibres. In each of the three fibres 26, 27 and 28 (distributed every 120°), a Bragg grating is photoimprinted so as to measure the deformations at the level of each of the cores of these fibres. These three gratings are located in the same planar section of the cable.

The maximum deformations sustained by each of the gratings thus changes according to εₘₐₓ=Φₑₓₜ/ρ. The system of equations applicable to the structure of FIG. 2 is the same as the system of equations (10), below, replacing the term Φ/2 (radius of the cable) with the term Φₑₓₜ (diameter of each fibre).

An additional photoimprinted Bragg grating can be incorporated in the assembly so as to allow for temperature compensation. Rather than putting it on the exterior, it is more advantageous to photoimprint this grating in the core of the central fibre 25. As it is located on the neutral fibre, the core of this fibre 25 is not subjected to any deformation induced by the curvature. It is, however, sensitive to the same effect caused by the temperature and the axial deformation so that it makes it possible to perform a direct compensation of these terms simultaneously according to the simple equation (applied on all of the gratings by angular permutations of 120°):

$$\frac{{Δλ}_{a}}{{Δλ}_{a}} - \frac{{Δλ}_{d}}{{Δλ}_{d}} = \frac{{Φ}_{ext}}{ρ} \cdot cos ψ \cdot ( 1 - {p}_{e} )$$

### Instrumentation and Optical Wiring of the Device

The fibres 12 glued to the reinforcement 11, for example in the three grooves 15, 16 and 17, are recollected via a multistrand optical cable that transmits the measurement to an apparatus. The fibres at the end of the device are then split again so as to be connected to an optical switch.

A plurality of Bragg grating reading instruments can be used to acquire the spectral data. For example, a portable apparatus incorporating a wide source (erbium-doped fibre emitting at 1.55 μm) and an interferometric scanning cavity can be used, as described in the document referenced [4].

### Acquisition of Data

In the solution shown in FIGS. 1A and 1B, the data is acquired for each series of six values for each measurement line l (1≦l≦30). Let p be the number of the fibre portion located on each of the grooves (1≦p≦10). The first groove 15 is equipped progressively (p=1, then p=2, etc. to p=10) by lines l=1 to 10, the second groove 16 by lines 11 to 20 and the third groove 17 by lines 21 to 30. Let k be the number of the grating on each line l (1≦k≦6), each groove j (1≦j≦3) has ten fibres (and therefore 60 gratings) according to the example above.

The correspondence ε (l, k) is known for each construction (the distribution of gratings on each fibre is known as is the distribution of the fibres on the reinforcement). l and k are thus the only two parameters accessible to the operator. From these two wiring parameters, all of the other parameters are deduced by a correspondence procedure that makes it possible to distribute and reorder the values within a single deformation table. Let DEF (j, i) be one such table with dimensions 3×60 (according to the example above) of which the indices correspond to groove j (1≦j≦3) and the abscissa i (1≦i≦60) along the device. The position x(i) corresponding to the abscissa i is noted xᵢ below. The counting of the number of fibre portions glued to the reinforcement provides the equation:

l=10.(j−1)+p (4)

The correspondence to be established in order to reorder the data in the deformation table of index (j, i) is then as follows:

j=ent (l/10)+1 (5)

p=l−10.ent (l/10) (6)

i=6.p+k (7)

where the function ent( ) signifies a whole part.

Advantageously, the Bragg gratings can be placed according to a period h having a constant value, so that the positions of the gratings are described by the simple equation: xᵢ=i*h.

Other arbitrary configurations are also possible. Below, we will consider the general case of a non-constant period hᵢ=xᵢ₊₁−xᵢ.

### Storage Procedure and Installation on the Site

The device of the invention can be wound after production in the factory and unwound on location so as to be installed on the site. The device is therefore stored for a period before its installation.

### Storage

The gratings must withstand the storage deformation for a period that can sometimes be long and under conditions that are rarely controlled (temperature, moisture). Consequently, the diameter Φ of the device is defined in order to prevent excessive storage deformation on the Bragg transducers so as to ensure their performance over time. However, it is necessary to prevent the diameter of the device from being too small so as to ensure its shear strength under worksite conditions and to optimise the sensitivity of the curvature radius. When considering a Bragg transducer glued in the curvature plane, the bending deformation ε_{f} is directly dependent on the local curvature radius of the cable ρ according to the following equation:

$${ɛ}_{f} = \frac{Φ}{2 \cdot ρ} \qquad ( 8 )$$

If we consider storage reels having a diameter of 1 m (i.e. a 0.5 m curvature radius), a maximum device diameter of 5 mm is obtained for a maximum allowable storage deformation of 0.5%, which is satisfactory.

### Installation on Site

First, a steel or composite pull cable is inserted into the tunnel. This operation can be performed concomitantly to the installation of the device, or even beforehand. This latter solution is preferable because the borehole is most often cased with “sleeve tubes” over its entire length. This makes it possible to prevent local damage to an excavation caused by the convergence of the ground, and facilitates the insertion of the device by reducing friction. The pull cable is then connected to one of the fasteners crimped to the reinforcement of the device. The latter is then towed inside the tunnel by pulling on the pull cable so as to extract it from the tunnel and introduce the device into said tunnel.

If we consider a 50% glass-50% epoxy composite reinforcement, the maximum allowable pull force (corresponding to a maximum allowable deformation ε) is written:

$$F = \frac{π}{4} \cdot {Φ}^{2} \cdot E \cdot ɛ \qquad ( 9 )$$

For a maximum allowable deformation of 0.5%, the corresponding maximum force is 5.6 kN, i.e. around 570 kg. This maximum allowable pull force is compatible with the stress to be exerted so as to install it on the site. However, an additional line can be added for safety reasons. Mortar (bentonite) can then be injected so as to secure the device on the ground. A “zero condition” deformation measurement is then taken so as to serve as a point of comparison of the future development of the settlement.

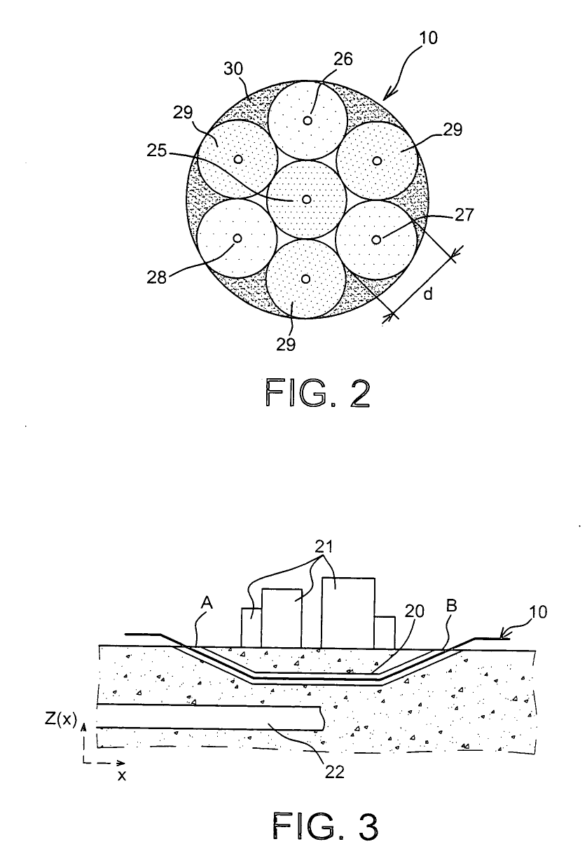

FIG. 3 diagrammatically shows such an installation in which a tunnel 20 is created so as to place the device of the invention 10 under buildings 21, above a tunnel under construction 22. The end points A and B of the tunnel 20 must be stationary points (outside of the area to be monitored). The hole at point A can be a non-through-hole (blind hole). In the case of holes opening out at points A and B, an apparatus can be arbitrarily connected to point A or point B. In the case of rupture (caused by a collapse), the apparatus must be connected to point A and point B successively (or by optical switch) so as to acquire the entirety of the measurement line.

### Processing of Data and Calculation of the Settlement Profile

The reading apparatus provides three tables on the deformation of the section of the device according to the distance x along said device, and a table for measuring temperatures making it possible to establish any thermal correction necessary. The data processing corresponds first to the separation of the axial pulling ε and bending parameters (radius of curvature ρ) for each abscissa x. Then, the table of second derivatives Z″(x) is deduced, with which the settlement Z(x) is reconstructed.

### Separation of Parameters

Each table corresponds to a measurement of deformations on one of the three grooves 15, 16 or 17 shown in FIG. 1B, oriented, for example, at 120° with respect to one another. The first table corresponds to the measurement εₐ(x), the second to ε_{b}(x) and the third to ε_{c}(x). For each point xᵢ of the device, the overall system to be solved is the following:

$$\{ \begin{matrix}Δ {λ}_{a} = {λ}_{a} \cdot [ ɛ + \frac{Φ}{2 \cdot ρ} \cdot cos ψ ] \cdot ( 1 - {p}_{e} ) + {λ}_{a} \cdot {a}^{′} \cdot Δ T \\ Δ {λ}_{b} = {λ}_{b} \cdot [ ɛ + \frac{Φ}{2 \cdot ρ} \cdot cos ( ψ + \frac{2 \cdot π}{3} ) ] \cdot ( 1 - {p}_{e} ) + {λ}_{b} \cdot {a}^{′} \cdot Δ T \\ Δ {λ}_{c} = {λ}_{c} \cdot [ ɛ + \frac{Φ}{2 \cdot ρ} \cdot cos ( ψ \frac{2 \cdot π}{3} ) ] \cdot ( 1 - {p}_{e} ) + {λ}_{c} \cdot {a}^{′} \cdot Δ T\end{matrix} \qquad ( 10 )$$

for which the parameters of the fibres have previously been defined. The angle ψ corresponds to the orientation of the first transducer with respect to the plane of the curvature (or with respect to the normal to the neutral diametral plane of the device), a′ is given by equation (2) and pₑ is given by equation (3).

The measurement of different in temperature ΔT (with respect to the known absolute temperature reference state) is provided by a temperature grating placed in the vicinity. The temperature difference ΔT is then given by equation (1).

The deformations are then obtained by the following equation provided by way of example, for εₐ:

$${ɛ}_{a} = \frac{Δ {λ}_{a} - \frac{{λ}_{a}}{{λ}_{T}} \cdot \frac{{a}^{′}}{a} \cdot Δ {λ}_{T}}{{λ}_{a} \cdot ( 1 - {p}_{e} )} \qquad ( 11 )$$

In practice, the operator can consider the wavelengths to be very close: λₐ≈λ_{b}≈λ_{c}≈λ_{T}. This approximation is true at better than 1%. From the system of equations (10), the system of deformations corrected for the temperature effect is deduced by calculation.

$$\{ \begin{matrix}{ɛ}_{a} = ɛ + \frac{Φ}{2 \cdot ρ} \cdot cos ψ \\ {ɛ}_{b} = ɛ + \frac{Φ}{2 \cdot ρ} \cdot cos ( ψ + \frac{2 \cdot π}{3} ) \\ {ɛ}_{c} = ɛ + \frac{Φ}{2 \cdot ρ} \cdot cos ( ψ - \frac{2 \cdot π}{3} )\end{matrix} \qquad ( 12 )$$

This three-equation system makes it possible to determine the three unknowns (ε,ρ and ψ). The axial deformation is then written:

$$ɛ = \frac{{ɛ}_{a} + {ɛ}_{b} + {ɛ}_{c}}{3} \qquad ( 13 )$$

It conventionally corresponds to the spherical part of the solution of rosette equations. The angle ψ, can be determined by the following equation, with

−π/2<Ψ<π/2:

$$tg ( ψ ) = \frac{{ɛ}_{b} - {ɛ}_{c}}{\sqrt{3 \cdot ( {ɛ}_{a} - ɛ )}} \qquad ( 14 )$$

Knowing ψ and ε, the local radius of curvature ρ is deduced by the first equation of the system (12) and by applying the well-known trigonometric equation:

$$cos ( ψ ) = \frac{1}{\sqrt{1 + {tg ( ψ )}^{2}}} \qquad ( 15 )$$

The deformation due exclusively to the bending ε_{f}(x) is then a function of the local radius of curvature of the device according to the equation:

$${Z}^{″} ( x ) = \frac{1}{ρ ( x )} = K \cdot {ɛ}_{f} ( x ) \qquad ( 16 )$$

where K is a calibration constant that depends on the diameter of the device and the binding conditions (in first approach: K=2/Φ). The correction of temperature effects is performed on the measurement of pull deformation ε (equation 13).

Reconstruction of the Settlement Profile Z(x)

When the bending deformation profile ε_{f} (X), is known, it is possible to deduce the profile of the curvature radii and the function Z″(x) according to equation (16). This equation can be integrated first to obtain the settlement gradient Z′(x), then to deduce Z(x) therefrom. The integration can be achieved by the modified Euler's method. This method is different from the traditional Euler's method in the sense that it takes into account the average of the two extreme derivatives (at points i and i+1) instead of considering only the first derivative (at point i). The first derivatives Z′i are calculated by the following recurrence equation:

$${Z}_{i + 1}^{′} = {Z}_{i}^{′} + \frac{{h}_{i}}{2} \cdot ( {Z}_{i}^{″} + {Z}_{i + 1}^{″} ) \qquad ( 17 )$$

This method corresponds to a limited Taylor series expansion of order 2. The expansion equation (17) is initiated by the conditions at the limits Z′₁=0 and Z′(Xₙ)=0. Other methods corresponding to series expansions of higher orders can be applied.

The settlement profile Z(x) is then obtained by a second integration according to a limited Taylor series expansion of order 2, incorporating Z′ and Z″, with Z₁=0 and Zₙ=0 (reference zones) as boundary conditions. The settlement profile is then obtained by the following recurrence equation (Taylor, order 2):

Zᵢ₊₁=Zᵢ+Z′_{i.}hᵢ+Z″_{i.}hᵢ²/2 (18)

Another solution takes into account the properties of adjustment by so-called “spline” functions described in the document referenced [5]. This principle of adjustment consists of finding a series of polynomials each connecting points in the most homogeneous manner possible, connecting them by applying continuity conditions on the values and the first derivatives. This mathematical adjustment therefore respects the physical continuity of the physical medium. As polynomials for interpolating the settlement profile, polynomials of order 3 (hence the term “cubic spline”) having the following form are sought:

Zᵢ(x)=a_{i.}(x−xᵢ)³+b_{i.}(x−xᵢ)²+c_{i.}(x−xᵢ)+dᵢ (19)

Z₁(x) is a point of the curve of the spline function interpolated between each experimental point Aᵢ(xᵢ,Zᵢ) and Aᵢ₊₁(xᵢ₊₁, Zᵢ₊₁). Therefore, there are as many sets of parameters (aᵢ, bᵢ, cᵢ, dᵢ) as there are segments Aᵢ Aᵢ₊₁. Thus, if n is the number of experimental points, there are (n−1) intervals and 4.(n−1) parameters to describe this “spline” function.

Let us consider the interval [i, i+1], having a width hᵢ, limited by the points Aᵢ and Aᵢ₊₁. For each of these two points, the equation of the “spline” function Zᵢ(x) can be applied. Thus, the following two equations are obtained, for the same interval i:

For x=xᵢ: Zᵢ=dᵢ (20)

For x=xᵢ₊₁: Zᵢ₊₁=a_{i.}hᵢ³+b_{i.}hᵢ²+c_{i.}hᵢ+dᵢ (21)

The continuity of the spline function (at point i+1) is obtained by recurrence:

Zᵢ₊₁=dᵢ₊₁=a_{i.}hᵢ³+b_{i.}h²+c_{i.}hᵢ+dᵢ (22)

Similarly, the equations on the first derivative at point i (x=xi) are:

For the interval [i, i+1] at point x=xᵢ: Z′ᵢ=cᵢ (23)
For the interval [i−1, 1] at point x=xᵢ:

Z′ᵢ₋₁=3.aᵢ₋₁.hᵢ₋₁²+2.bᵢ₋₁.hᵢ₋₁+cᵢ₋₁ (24)

These two derivatives must be equal in order to ensure the continuity of the slopes. Thus, we obtain the continuity equation on the first derivatives:

Z′ᵢ=cᵢ=Z′ᵢ₋₁=3.aᵢ₋₁.hᵢ₋₁²+2.bᵢ₋₁.hᵢ₋₁+cᵢ₋₁ (25)

To simplify the procedure, it is routine to put these equations in a function of second derivatives of the “spline” function. This second derivative is written as follows, for each interval i:

Z″(x)=6.aᵢ.(x−xᵢ)+2.bᵢ (26)

We then define the vectors Sᵢ (xᵢ) representing the second derivative on each of the intervals. For each of the two points Aᵢ and Aᵢ₊₁ defining the interval i, it is possible to apply equation (26) and thus obtain, for the same interval i:

For x=xi: Sᵢ=2.bᵢ (27)

For x=xᵢ₊₁: Sᵢ₊₁=6.aᵢ.hᵢ+2bᵢ (28)

It is then possible to formulate the parameters aᵢ, bᵢ and cᵢ directly as a function of vectors Sᵢ. We thus obtain:
According to equation (27):

$${b}_{i} = \frac{{S}_{i}}{2} \qquad ( 29 )$$

According to equation (28):

$${a}_{i} = \frac{( {S}_{i + 1} - {S}_{i} )}{6 \cdot {h}_{i}} . \qquad ( 30 )$$

According to equations (20) and (21):

$${c}_{i} = \frac{{Z}_{i + 1} - {Z}_{i}}{{h}_{i}} - {a}_{i} \cdot {h}_{i}^{2} - {b}_{i} \cdot {h}_{i}$$

By replacing aᵢ and bᵢ as a function of Sᵢ (equations (29) and (30)), we obtain:

$${c}_{i} = \frac{{Z}_{i + 1} - {Z}_{i}}{{h}_{i}} - \frac{{h}_{i}}{6} \cdot ( {S}_{i + 1} - {S}_{i} ) - \frac{{S}_{i}}{2} \cdot {h}_{i}$$

The first term corresponds to a gradient of the settlement profile, so that the equation is rewritten:

$${c}_{i} = {Z}_{i}^{′} - \frac{{h}_{i}}{6} \cdot ( {S}_{i + 1} - {S}_{i} ) - \frac{{S}_{i}}{2} \cdot {h}_{i} \qquad ( 31 )$$

Equation (25) can be rewritten as a function of these parameters Sᵢ, by replacing aᵢ, bᵢ and cᵢ with their values given respectively by equations (30), (29) and (31). We thus obtain the continuity equation corresponding to the following recurrence equation:

Sᵢ₋₁.hᵢ₋₁+2.Sᵢ.(hᵢ+hᵢ₋₁)+Sᵢ₊₁.hᵢ=6.(Zᵢ′−Zᵢ₋₁′) (32)

In the case of a constant period hᵢ₋₁=hᵢ=hᵢ₊₁, this continuity equation is simplified and becomes:

Sᵢ₋₁+4.Sᵢ+Sᵢ₊₁=6.Zᵢ″ (33)

The recurrence equation (33) making it possible to determine the parameters Sᵢ (and thus to construct the “spline” curve) is therefore directly a function of the second derivative of the settlement profile Zᵢ, i.e. proportional to the distribution of the bending deformations measured.

Equations (32) and (33) are valid for 2≦i≦n−1, that is n−2 equations. It is therefore appropriate to add two other equations corresponding to the boundary conditions so as to definitively construct the spline curve.

The two reference zones at each end of the device are intended to define the initial conditions for the settlement function and its two derivatives Z′ and Z″. Once installed on the reference zones, the ends of the device are thus at elevation, stationary and horizontal, at the tunnel outlet (Z′ᵢ=0 and Z′ₙ=0). To illustrate this, we consider a constant reference elevation at A and at B (Z₁=0, Zₙ=0). In addition, we consider that at least two measurement zones are placed horizontally according to this reference zone so that Z″ᵢ=0 and Z″ₙ=0. According to equations (20) and (23), it follows respectively that d₁=0, dₙ=0 and that c₁=0 and cₙ=0. The parameters (a₁, b₁) and (aₙ, bₙ) are also consequently zero, as are the parameters S₁, S₂, Sₙ₋₁ and Sₙ.

Equation (33) is represented in matrix form in the form M_{iξ}=Sᵢ Z_{ξ}″. This equation can be solved by an iterative method or by calculating the inverse matrix of which the vector Sᵢ is deduced by calculating the inverse matrix

$${M}_{i ξ}^{- 1} = \frac{{coM}_{i ξ}^{T}}{Det ( {M}_{i ξ} )} .$$

The vectors aᵢ and bᵢ are then deduced from equations (30) and (29) respectively. The errors attributable to these parameters are primarily experimental because the calculations are very simple and do not lead to significant errors of numerical analysis.

The parameters cᵢ and dᵢ are then deduced respectively from recurrence equations (25) and (22) (continuity equations) in consideration of the initial conditions described above. This reconstruction can be achieved from both ends so as to divide by two the maximum number of points to be processed (typically 2×30 points for a 60-meter cable).

### Quantitative Analysis of Results

The uncertainty about the measurement of the settlement depth can be estimated by taking into account the uncertainty about the measurement of the deformation. Indeed, public works companies require a precision of ±1 mrad (error of depth of 1 mm over one meter of spatial period). The uncertainty about the angular gradient is written:

$$Δ [ \frac{d α ( x )}{d x} ] = 1 mrad / m = \frac{2}{Φ} \cdot {Δ}_{{ɛ}_{f}} ( x ) \qquad ( 34 )$$

For an equipped cable with a diameter of 5 mm, the uncertainty of the corresponding deformation measurement is ±2.5 micrometers/meter. This desired precision for the amplitude of the settlement can be obtained with the means proposed especially if performing a time averaging on a plurality of values so as to reduce the uncertainty of the wavelength measurement.

The local curvature information can finally be compared to the local pull information. This examination provides information on the type of ground settlement encountered. In the case of a significant settlement with an arc of circle with a 1 m bend, the average radius of curvature is written ρ=L²/(8.z) and is 450 meters for a 60-meter-long cable. The average deformation due to the pull varies at the first order as ε=2.z²/l² and is around 560 micrometers/meter. However, the deformation caused by the curvature is only 6 micrometers/meter, a relatively low value, close to the instrumentation resolution. In this situation, the deformation caused by the pull can therefore considerably exceed the deformation caused by the curvature.

Conversely, the curvature deformation can exceed the pull deformation in the case of a significant local curvature (localised ground settlement and pure curvature, without pull, of the cable). This situation is encountered in particular in the case of a discontinuity in the settlement profile causing a shear force on the cable (and therefore a significant bending moment).

### EXAMPLES OF APPLICATIONS

While initially designed for civil engineering-type applications, the system of the invention can be used in numerous sectors for applications requiring a distributed measurement of deformation and bending, and even detection of cracks.

In the civil engineering field, it can be used to monitor the development of non-uniform settlements and even unforeseen collapses that may cause serious accidents and lead to very high repair costs. A large number of infrastructures are concerned, including buildings, engineered constructions, towers, bridges, dams, roadways, railways, airports, as well as ground or off-shore transports by pipelines that are buried or placed at the ocean floor, for example, the curvature of a riser pipe at the point of contact with the ground. It can also monitor the change in the ground during the boring of galleries or tunnels under structures already built so as not to cause damage. During the driving of excavation work, surveillance of the ground (deformation, pitch) then makes it possible to control a cement injection station in the delicate areas so as to compensate for the settling of the ground (so-called compensation injection).

The system of the invention can also be applied to other sectors, such as aeronautics, for the measurement, on-board or not, of distributed deformations in a complex structure (for example a wide-body aircraft).

### REFERENCES

[1] U.S. Pat. No. 5,321,257
[2] “Industrial applications of the BOTDR optical fiber strain sensor” by H. Ohno, H. Naruse, M. Kikara and A. Shimada (opt. Fiber Tech., 7, 2001, pages 45-64).
[3] FR 2791768
[4] “Health monitoring of the Saint-Jean Bridge of Bordeaux, France, using Fiber Bragg gratings Extensometers” by S. Magne, J. Boussoir, S. Rougeault, V. Marty-Dewynter, P. Ferdinand, and L. Bureau (SPIE 5050, Conf. on Smart Structures and Materials, 2-6 Mar. 2003, San Diego, Calif., USA, pages 305-316)
[5] “Applied Numerical Analysis” by C. F. Gérald (Addison-Wesley, 1970, pages 290-293)

1. System for distributed or dispersed measurement of axial and bending deformations of a structure including at least one threadlike device (10) equipped for the distributed or dispersed measurement of these axial and bending deformations, and means for processing measurement signals generated by said device, characterised in that each device includes a cylindrical reinforcement (11) supporting, at its periphery, at least three optical fibres (12) locally parallel to the axis of the reinforcement, and in that the processing means implement means for spectral or time division multiplexing of signals coming from optical fibres.

2. System according to claim 1, characterised in that each fibre has at least one Bragg grating transducer, in which the processing means allow for a distributed measurement, and in which the multiplexing means are wavelength multiplexing means.

3. System according to claim 1, characterised in that the processing means allow for a dispersed measurement performed by the Brillouin reflectometry method.

4. System according to claim 1, characterised in that the optical fibres (12) are arranged in at least three grooves formed at the periphery of the reinforcement.

5. System according to claim 4, characterised in that the reinforcement is solid or hollow.

6. System according to claim 1, characterised in that it includes at least one additional optical fibre that makes it possible to achieve a temperature self-compensation.

7. System according to claim 6, characterised in that said additional optical fibre has Bragg gratings distributed along its entire length.

8. System according to claim 6, characterised in that said additional optical fibre is freely inserted into a low-friction plastic capillary.

9. System according to claim 1, characterised in that the device (10) includes an outer casing (18).

10. System according to claim 1, characterised in that the reinforcement is obtained by pultrusion of a glass-epoxy- or glass-vinylester-type composite material.

11. System according to claim 1, characterised in that metal fasteners are crimped on the reinforcement (11).

12. System according to claim 1, characterised in that the optical fibres are recollected via a multistrand optical cable that transmits the measurement to processing means.

13. System according to claim 1, characterised in that the reinforcement (11) is created by a positioning fibre (25).

14. System according to claim 13, characterised in that it includes seven fibres (25, 26, 27, 28, 29) having the same diameter, self-positioned in a hexagonal pattern, three fibres (26, 27, 28), distributed at 120° at the periphery of the reinforcement, being optical fibres.

15. System according to claim 14, characterised in that the fibres are coated with a polymer glue (30).

16. System according to claim 14, characterised in that the fibres are held by a capillary.

17. System according to claim 13, characterised in that the reinforcement is an optical fibre (25).

18. System according to claim 17, characterised in that at least one Bragg grating is inscribed in this fibre (25) so as to allow for a temperature compensation.

19. Application of the system according to any one of the previous claims, characterised in that the system is applied to the distributed or dispersed measurement of axial and bending deformations of a ground capable of collapsing.
